(19) United States
(12) Patent Application Publication
(10) Pub. No.: US 2025/0132970 A1
(43) Pub. Date: Apr. 24, 2025

(54) ANOMALY DETECTION BASED ON MULTI-MODAL DATA ANALYSIS

(71) Applicants: AT&T Intellectual Property I, L.P., Atlanta, GA (US); College of William & Mary, Williamsburg, VA (US)

(72) Inventors: Zhengyi Zhou, Chappaqua, NY (US); Venson Shaw, Kirkland, WA (US); Qiong Wu, Bridgewater, NJ (US); Wen-Ling Hsu, Bridgewater, NJ (US); Guy Jacobson, Bridgewater, NJ (US); Huajie Shao, Williamsburg, VA (US); Viet Quoc Duong, Williamsburg, VA (US)

(21) Appl. No.: 18/490,719

(22) Filed: Oct. 19, 2023

(51) Int. Cl. H04L 41/0654; H04L 41/0631; H04W 4/38

(52) U.S. Cl. CPC H04L 41/0654; H04L 41/0631; H04W 4/38

(57) ABSTRACT

A method performed by a processing system including at least one processor includes collecting a set of data from a plurality of sensors that is monitoring a system, wherein the plurality of sensors includes sensors of a plurality of different modalities, detecting an instance of out-of-distribution data in the set of data by providing the set of data as an input to a machine learning model that generates as an output an indicator that the instance of out-of-distribution data is out-of-distribution with respect to the set of data, identifying a root cause for the instance of out-of-distribution data, and initiating an action to remediate the root cause of the instance of out-of-distribution data.

The present disclosure relates generally to machine learning, and relates more particularly to devices, non-transitory computer-readable media, and methods for using machine learning techniques to analyze multi-modal data for the purpose of detecting anomalies.

### BACKGROUND

Machine learning is a useful tool for detecting anomalies in data sets. For instance, a machine learning model may be trained to detect anomalies using a set of training data, which may comprise actual data collected from the system in which the anomalies are to be detected (or a similar system). By training on the training data, the machine learning model can learn which data patterns may be considered normal and which data patterns may be considered anomalous in a set of test data collected from the system (e.g., data similar to, but not included in, the training data). A well-trained machine learning model should be capable of detecting anomalies much more quickly than a human technician, allowing for earlier remediation and thereby limiting the damage that the anomaly may cause.

### SUMMARY

The present disclosure broadly discloses methods, computer-readable media, and systems for detecting an anomaly based on analysis of multi-modal data. In one example, a method performed by a processing system including at least one processor includes collecting a set of data from a plurality of sensors that is monitoring a system, wherein the plurality of sensors includes sensors of a plurality of different modalities, detecting an instance of out-of-distribution data in the set of data by providing the set of data as an input to a machine learning model that generates as an output an indicator that the instance of out-of-distribution data is out-of-distribution with respect to the set of data, identifying a root cause for the instance of out-of-distribution data, and initiating an action to remediate the root cause of the instance of out-of-distribution data.

In another example, a non-transitory computer-readable medium may store instructions which, when executed by a processing system including at least one processor, cause the processing system to perform operations. The operations may include collecting a set of data from a plurality of sensors that is monitoring a system, wherein the plurality of sensors includes sensors of a plurality of different modalities, detecting an instance of out-of-distribution data in the set of data by providing the set of data as an input to a machine learning model that generates as an output an indicator that the instance of out-of-distribution data is out-of-distribution with respect to the set of data, identifying a root cause for the instance of out-of-distribution data, and initiating an action to remediate the root cause of the instance of out-of-distribution data.

In another example, a device may include a processing system including at least one processor and a non-transitory computer-readable medium storing instructions which, when executed by the processing system, cause the processing system to perform operations. The operations may include collecting a set of data from a plurality of sensors that is monitoring a system, wherein the plurality of sensors includes sensors of a plurality of different modalities, detecting an instance of out-of-distribution data in the set of data by providing the set of data as an input to a machine learning model that generates as an output an indicator that the instance of out-of-distribution data is out-of-distribution with respect to the set of data, identifying a root cause for the instance of out-of-distribution data, and initiating an action to remediate the root cause of the instance of out-of-distribution data.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for detecting an anomaly based on analysis of multi-modal data may operate;

FIG. 2 illustrates a flowchart of an example method for detecting an anomaly based on analysis of multi-modal data, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for using machine learning techniques to analyze multi-modal data for the purpose of detecting anomalies. As discussed above, machine learning is a useful tool for detecting anomalies in data sets. For instance, a machine learning model may be trained to detect anomalies using a set of training data, which may comprise actual data collected from the system in which the anomalies are to be detected (or a similar system). By training on the training data, the machine learning model can learn which data patterns may be considered normal and which data patterns may be considered anomalous in a set of test data collected from the system (e.g., data similar to, but not included in, the training data). A well-trained machine learning model should be capable of detecting anomalies much more quickly than a human technician, allowing for earlier remediation and thereby limiting the damage that the anomaly may cause.

Most deep learning machine learning models are trained based on the assumption that the test data will share the same distribution as the training data. However, test data will not necessarily always follow the same distribution as the training data. Test data for which the distribution varies from the distribution of the training data may be referred to as “out-of-distribution” (or “OOD”) data. The presence of OOD data in the test data can cause a significant decrease in the accuracy of the machine learning model's output. While this decrease in accuracy may present no more than an inconvenience for some types of systems, it could lead to serious, and potentially even dangerous, consequences in other types of systems, such as autonomous driving systems and medical/healthcare systems.

Although approaches do exist for detecting OOD data in a set of test data, these approaches tend to focus on OOD data detection for specific fields, and thus typically process data of no more than a single modality. For instance, an approach for detecting OOD data in a computer vision system might be trained to detect OOD visual data (e.g., still and/or video images), even though OOD instances may occur in audio data (e.g., audio recordings), text data (e.g., tabular information), and data of other modalities.

Examples of the present disclosure use machine learning techniques to analyze multi-modal data for the purpose of detecting anomalies, or out-of-distribution data, in a set of test data collected by a system. The analysis of multiple modalities greatly enhances the accuracy and interpretability of out-of-distribution data. For instance, analysis of multiple modalities such as image data, audio data, and video data collected by a drone, as well as performance metrics and other numerical data collected by network sensors, might enable a machine learning technique to learn various features of abnormally functioning radio access network (RAN) base stations. The various features may then be more readily correlated in order to quickly detect base stations that are not functioning properly. Thus, by analyzing data across multiple modalities rather than a single modality, anomalies can be detected and remediated more quickly. Moreover, the analysis of multiple modalities may allow the root causes of detected anomalies to be identified more quickly.

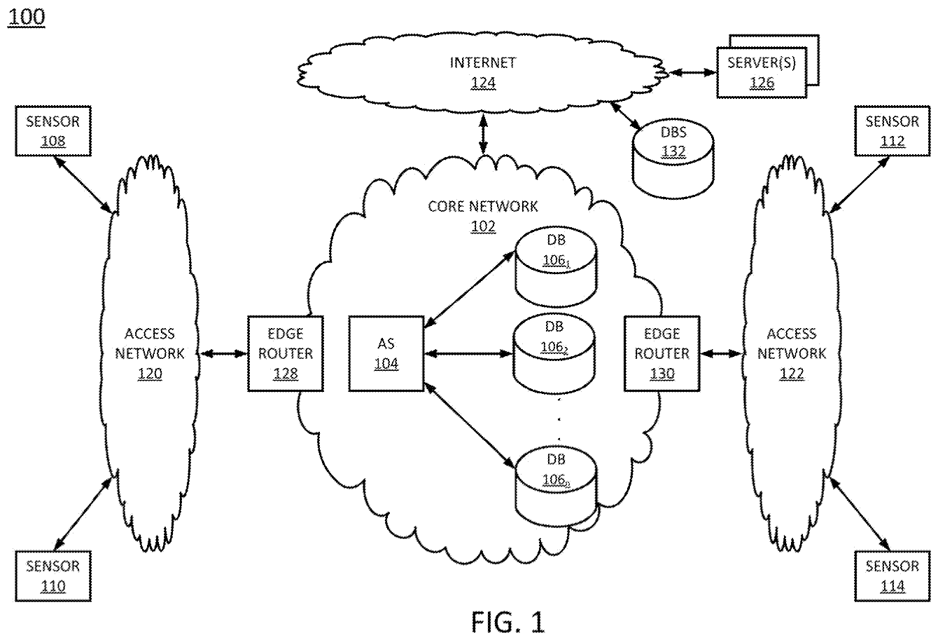

Thus, examples of the present disclosure may simplify maintenance of a communications network infrastructure by detecting anomalies in RAN base stations before the damage caused by the anomalies becomes more costly to repair. However, examples of the present disclosure may enhance applications beyond communications networks as well. These and other aspects of the present disclosure are discussed in greater detail below in connection with the examples of FIGS. 1-3.

To further aid in understanding the present disclosure, FIG. 1 illustrates an example system 100 in which examples of the present disclosure for detecting an anomaly based on analysis of multi-modal data may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, a plurality of databases (DBs) 1061-106n (hereinafter individually referred to as a “database 106” or collectively referred to as “databases 106”), and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

In one example, the access network 120 may be in communication with one or more sensors 108 and 110. Similarly, the access network 122 may be in communication with one or more sensors 112 and 114. The access networks 120 and 122 may transmit and receive communications between the sensors 108, 110, 112, and 114, between the sensors 108, 110, 112, and 114, the server(s) 126, the AS 104, other components of the core network 102, devices reachable via the Internet in general, and so forth.

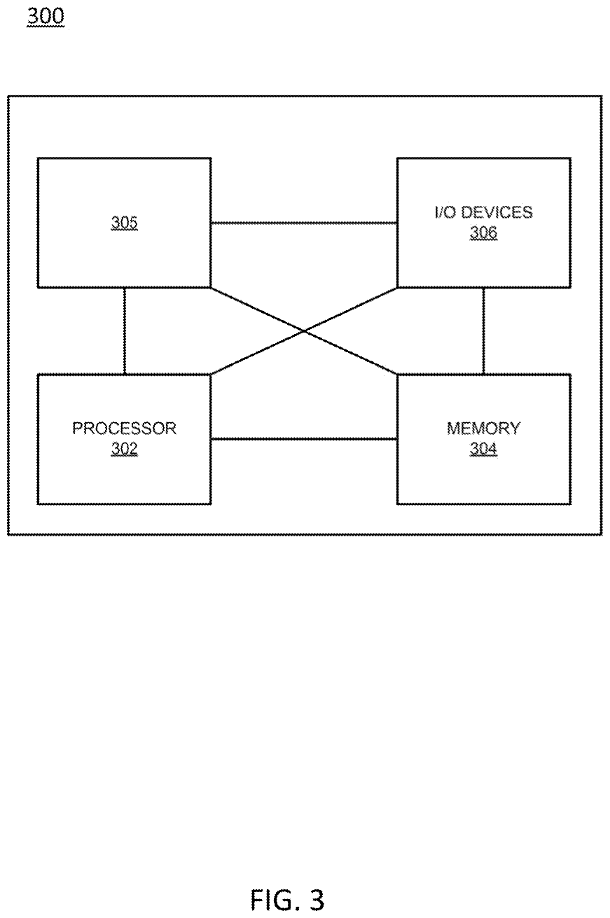

In one example, each of the sensors 108, 110, 112, and 114 may comprise any single device or combination of devices that may comprise a sensor, such as computing system 300 depicted in FIG. 3, and may be configured as described below. For example, the sensors 108, 110, 112, and 114 may each comprise an imaging sensor (e.g., a still or video camera), an audio sensor (e.g., a microphone or transducer), a network sensor (e.g., a probe or other devices located in a communications network in order to monitor network conditions or obtain network performance metrics), a temperature sensor (e.g., a thermometer or a thermocouple), a weather sensor (e.g., a barometer or humidity sensor), a medical sensor (e.g., a heart rate monitor, a blood glucose monitor, or a blood pressure monitors), and/or a biometric sensor (e.g., a fingerprint scanner, an ocular recognition device, or a voice recognition system).

In one example, at least some of the sensors may be mounted in a fixed location (e.g., to a building, to a base station of a RAN, to a traffic signal or sign, etc.). In one example, at least some of the sensors may be mounted to a mobile object (e.g., mounted to a drone or a vehicle, carried by a human or an animal, or the like). In one example, the sensors 108, 110, 112, and 114 may be positioned throughout a system to collect data which may be analyzed by a machine learning model that is trained to detect out-of-distribution data which may be indicative of an anomaly in the system, as discussed in greater detail below.

In one example, one or more servers 126 and one or more databases 132 may be accessible to AS 104 via the Internet 124 in general. The server(s) 126 and DBs 132 may be associated with various data sources that collect data from sensors. Thus, some of the servers 126 and DBs 132 may store content such as images, text, video, metadata, and the like which may be used to train a machine learning model to detect instances of OOD data in a set of data collected by the sensors 108, 110, 112, and 114.

In accordance with the present disclosure, the AS 104 may be configured to provide one or more operations or functions in connection with examples of the present disclosure for detecting an anomaly based on analysis of multi-modal data, as described herein. The AS 104 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the AS 104 may be configured to detect an anomaly based on an analysis of multi-modal data. In particular, the AS 104 may be configured to identify instances of OOD data in a multimodal data set that is collected by a plurality of different types of sensors (i.e., sensors that collect data of a plurality of different modalities). In one example, the instance of OOD data may be indicative of an anomaly in a system being monitored. The instance of OOD data may be correlated with other data in the data set to confirm the presence of the anomaly.

In one example, the AS 104 may include one or more encoders (e.g., a different encoder for each modality of data that is collected) that transfer each instance of data into a latent representation for subsequent classification. The AS 104 may further include a machine learning-based classifier that takes the latent representations of the multimodal data set as input and generates as an output an indicator for instances of data in the data set that are deemed to be OOD. Each instance of data that is determined to be OOD may be further associated with a confidence or likelihood that the instance of data is OOD.

In one example, the AS 104 may be further configured to identify a root cause for an instance of OOD data and to initiate an action to remediate the root cause. For instance, if the root cause of an OOD image of a RAN base station is determined to be a bird nest that has been built on top of the base station, then the AS 104 may take an action such as temporarily deactivating the base station, postponing scheduled maintenance for the base station until the nest is removed, scheduling an examination of the base station by an agency that is authorized and/or trained to remove or relocate the nest, or the like.

In further examples, the AS 104 may retrain the machine learning-based classifier when a data shift is detected in the set of data. For instance, when the data shift is detected, the AS 104 may augment a set of training data used to train the machine-learning based classifier with OOD instances of data (which may actually be consistent with an evolving/new distribution of data rather than being OOD), and may initiate retraining of the machine learning-based classifier in order to train the classifier on the new distribution.

Furthermore, in one example, at least some of the DBs 106 may operate as repositories for data collected by the sensors 108, 110, 112, and 114, prior to the data being processed by the AS 104. For, instance each DB 106 may store data of one modality (e.g., still image, video, audio numerical/text values, etc.) that is recorded by one or more of the sensors 108, 110, 112, and 114. For instance, DB 1061 may store still images collected by one or more cameras, DB 1062 may store audio data collected by one or more microphones, DB 106ₙ may store numerical or text data collected by one or more network sensors, and the like. Thus, the DBs 106 may be continuously updated with new data as new data is collected by the sensors 108, 110, 112, and 114.

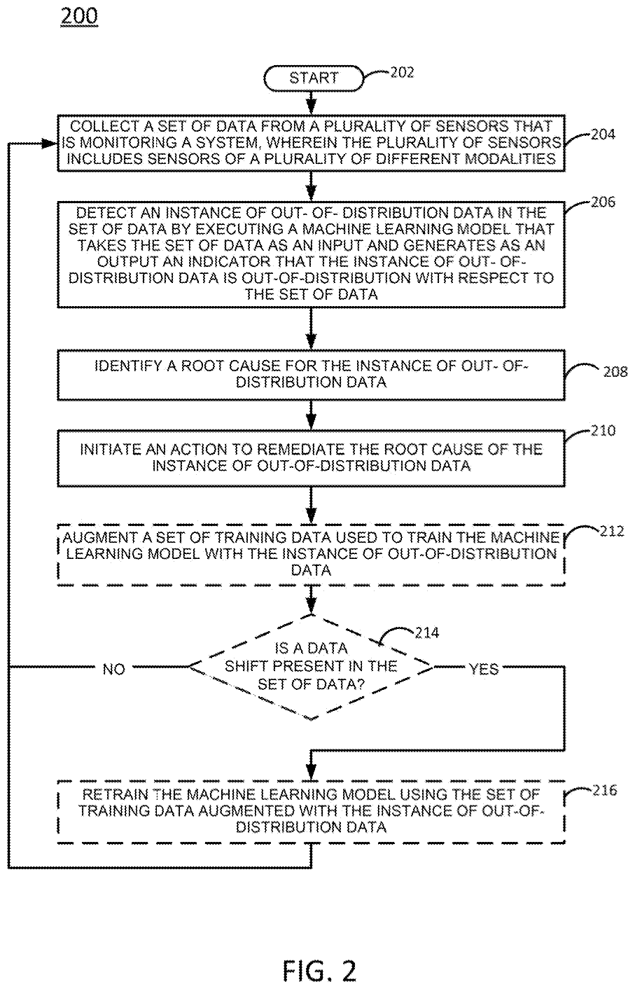

In one example, the DBs 106 may comprise physical storage devices integrated with the AS 104 (e.g., a database server or a file server), or attached or coupled to the AS 104, in accordance with the present disclosure. In one example, the AS 104 may load instructions into a memory, or one or more distributed memory units, and execute the instructions for detecting an anomaly based on an analysis of multi-modal data, as described herein. One example method for detecting an anomaly based on an analysis of multi-modal data is described in greater detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, sensor devices 108, 110, 112, and 114 may communicate with the core network 102 via different access networks, sensor devices 110 and 112 may communicate with the core network 102 via different access networks, and so forth. Thus, these and other modifications are all contemplated within the scope of the present disclosure.

FIG. 2 illustrates a flowchart of an example method 200 for detecting an anomaly based on an analysis of multi-modal data, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 300, and/or a processing system 302 (e.g., having at least one processor) as described in connection with FIG. 3 below. For instance, the computing device 300 may represent at least a portion of the AS 104 in accordance with the present disclosure. For illustrative purposes, the method 200 is described in greater detail below in connection with an example performed by a processing system, such as processing system 302.

The method 200 begins in step 202 and proceeds to step 204. In step 204, the processing system may collect a set of data from a plurality of sensors that is monitoring a system, wherein the plurality of sensors includes sensors of a plurality of different modalities.

In one example, the system may include a communications network (e.g., similar to the system 100 illustrated in FIG. 1, or a portion of the system 100). For instance, the system may comprise all or part of a RAN. In such a case, the sensors may be distributed throughout the communications network and may collect data relating to the physical and environmental conditions surrounding base stations and other physical infrastructures of the communications network, the strength of radio signals emitted by the base stations and other physical infrastructures, volumes of network traffic being processed by the base stations and other physical infrastructures, performance metrics of the base stations and other physical infrastructures (e.g., throughput, bandwidth, speed, etc.), and/or other data. In the case of an open RAN, the collected data may help to select which RANs to engage or not engage.

In another example, the system may comprise a human body that is being monitored or tested for disease. In this case, the sensors may be distributed throughout the human body (e.g., inside and/or in contact with various parts of the body) and may collect data relating to radiology images (e.g., X-ray, CT scan, PET scan, MRI, etc.), vital signs (e.g., heart rate, blood pressure, blood oxygenation, etc.), blood conditions (e.g., blood alcohol content, blood glucose levels, white blood cell count, hormone levels, fetal DNA, etc.), and/or other health markers.

In another example, the system may comprise an autonomous vehicle whose surrounding environment is being monitored for objects and conditions that may affect operations of the vehicle. In this case, the sensors may be distributed throughout the vehicle and the vehicle's surroundings (e.g., within the vehicle, mounted to the outside of the vehicle, mounted to fixed objects in the vehicle's surroundings such as buildings, traffic signals, and highway signs, or mounted to objects moving through the vehicle's surroundings as in the case of drones or sensors mounted on or within other vehicles) and may collect data relating to weather conditions (e.g., ice, rain, wind, etc.), road obstructions (e.g., accidents, animals, constructions, planned road closures, etc.), traffic density and speed, vehicle conditions (e.g., fuel level, tire pressure, engine oil life, etc.), and/or other conditions.

In another example, the system may comprise a piece of artwork that is being monitored or examined for authenticity. In this case, the sensors may be distributed throughout instruments that are used to examine the piece of artwork (e.g., cameras, mass spectrometers, radiometric dating tools, etc.) and may collect data relating to the appearance of the piece of artwork (e.g., signature, artistic style, brushstrokes, etc.), the age of the piece of artwork (e.g., decay of certain components in paints, coloration, or inks), location of origin (e.g., presence of certain components in paints, inks, canvases, or the like), and/or other data.

In another example, the system may comprise a physical location at which a crowd is gathered or expected to gather such as a public park, a stadium, an amusement park, a parade route, or the like. In this case, the sensors may be distributed throughout the physical location (e.g., mounted to fixed objects such as buildings or signage, mounted to moving objects such as drones, vehicles, or equipment carried by human employees, etc.) and may collect data relating to crowd sizes such as images of crowds, levels of communication network traffic originating in or terminating in the physical location, crowd noise levels, and/or other data. Such sensors could also be used to collect data relating to natural disasters in the physical location.

In another example, the system may comprise a piece of software that is under development. In this case, the sensors may include software sensors that are designed to detect errors in the source code for the piece of software and/or anomalies in the state of a computing system in which the piece of software is running.

As discussed above, the plurality of sensors includes sensors of a plurality of (i.e., at least two) different modalities. For instance, the sensors may include imaging sensors (e.g., still or video cameras, which may be fixed in specific locations, attached to drones or other mobile devices, or the like), audio sensors (e.g., microphones or transducers, which may be fixed in specific locations, attached to drones or other mobile devices, or the like), network sensors (e.g., probes or other devices located in a communications network in order to monitor network conditions), temperature sensors (e.g., thermometers, thermocouples, which may be fixed in specific locations, attached to drones or other mobile devices, or the like), weather sensors (e.g., barometers or humidity sensors, which may be fixed in specific locations, attached to drones or other mobile devices, or the like), medical sensors (e.g., heart rate monitors, blood glucose monitors, or blood pressure monitors, which may be worn by a human or an animal), and/or biometric sensors (e.g., fingerprint scanners, ocular recognition devices, or voice recognition systems, which may be fixed in specific locations, attached to drones or other mobile devices, or the like). Thus, the set of data may include at least two of: image data, audio data, text data, or metadata.

In step 206, the processing system may detect an instance of out-of-distribution data in the set of data by executing a machine learning model that takes the set of data as an input and generates as an output an indicator that the instance of out-of-distribution data is out-of-distribution with respect to the set of data.

In one example, an instance of data is OOD with respect to the set of data if a value for the instance of data deviates from a mean or median value for the set of data by more than a predefined threshold. For instance, for a communications network, a network performance parameter (e.g., throughput) that is below a threshold value for the performance parameter may be considered OOD. The predefined threshold may be tunable to adjust the sensitivity of the machine learning model (e.g., to allow for greater or lesser deviation).

The predefined threshold may also vary depending upon the modality of the instance of data and the purpose of the system. For instance, each modality of data collected by the plurality of sensors may be associated with a separate threshold for detecting instances of OOD data. In this case, the threshold may be simply the presence or absence of certain items or elements in an instance of data. For instance, if the system is a monitoring system that is designed to detect malfunctioning RAN base stations, then an image of a base station with a bird nest built on it, or with a broken antenna, may be considered OOD (while an image of a base station without a bird nest or a broken component may be considered in distribution). If the system is a medical diagnosis system that is designed to detect medical conditions, then the presence of fetal DNA may indicate that a blood sample is OOD (while the absence of fetal DNA may indicate that a blood sample is in distribution).

In one example, the machine learning model may comprise any machine learning model that is capable of performing OOD analysis, such as a machine learning model that is based on at least one of: a density-based algorithm, a reconstruction-based algorithm, a classification-based algorithm, or a distance-based algorithm. The machine learning model may be a supervised model, an unsupervised model, a self-supervised (e.g., contrastive learning) model, or a semi-supervised model.

In a further example, one or more encoders may be used to transfer the input data set into latent representations. For instance, a convolutional neural network (CNN) may be used to transfer images and videos into latent representations. The latent representations may subsequently be provided as input to a joint classification model that classifies items of data in the data set as OOD or not OOD.

In one example, an indicator that indicating whether an item of data is OOD may be a simple binary indicator (e.g., a value of zero, or a “no” flag, indicates that the item of data is in distribution, while a value of one, or a “yes” flag indicates that the item of data is OOD). In a further example, the indicator may be associated with a confidence indicating a degree of likelihood that the classification of “in distribution” or “OOD” is correct. For instance, the machine learning model may assign a score to each item of data in the set of data, where the score comprises an indication as to how closely the item of data fits the distribution of the data set. If the score is below a predefined lower threshold or above a predefined upper threshold, then the item of data may be classified as OOD, and a confidence associated with the classification may be proportional to how much below or above the threshold the score is. Similarly, if the score is above the predefined lower threshold or below the predefined upper threshold, then the item of data may be classified as in distribution, and a confidence associated with the classification may be proportional to how much above or below the threshold the score is. In another example, the score may be proportional to a distance between the score and a mean or median score for the data set.

In step 208, the processing system may identify a root cause for the instance of out-of-distribution data. There are a number of ways in which the root cause may be identified. For instance, in one example, the root cause may be identified automatically using a machine learning technique that examines features of the instance of OOD data from multiple different modalities. In one example, the machine learning technique may be trained using a supervised learning technique in which a human operator labels instances of OOD data in a set of training data with root causes. For instance, the machine learning technique may examine OOD photos and videos of a RAN base station that were captured by a drone, OOD numerical and/or textual performance metrics for the base station that were captured by network sensors, and/or other OOD data in order to determine that the RAN base station has ceased functioning, is malfunctioning, or is under-performing.

In a further example, a human operator may label a subset of the instances of OOD data in the set of training data, and a remainder of the instances of OOD data in the set of training data may be classified by the machine learning technique that has been trained using the labeled instances of OOD data. In another example, the processing system may search a repository of historical instances of OOD data for an historical instance of OOD data that most closely matches the instance of OOD data detected in step 206. The root cause associated with the most closely matching historical instance of OOD data may be assigned, at least on a preliminary basis, to the instance of OOD data detected in step 206.

In step 210, the processing system may initiate an action to remediate the root cause of the instance of out-of-distribution data. For instance, the instance of OOD data may indicate a RAN base station that has ceased functioning, is malfunctioning, or is under-performing. The root cause of the problem may be a bird's nest that has been built on the base station. In this case, the action to remediate might include identifying the location of the nest, the type of the bird(s) in the nest, and notifying an appropriate agency who may be authorized and/or trained to remove or relocate the nest. The action to remediate might also involve deactivating the RAN base station (or components of the RAN base station) at least temporarily, activating a redundant RAN base station (or component(s)), rerouting RAN network traffic, or the like.

In optional step 212 (illustrated in phantom), the processing system may augment a set of training data used to train the machine learning model with the instance of out-of-distribution data. In one example, the instance of OOD data may be labeled as OOD. In a further example, the instance of OOD data may also be labeled with the root cause that was identified in step 208, to aid in helping with root cause classification of instances of OOD data that are detected in the future. As discussed in further detail below, the augmented set of training data may subsequently be used to re-train the machine learning model used to detect instances of OOD data and/or to identify root causes of instances of OOD data.

In optional step 214 (illustrated in phantom), the processing system may determine whether a data shift is present in the set of data. In one example, a data shift may be detected when the occurrence of OOD data in the set of data is above a predefined threshold (e.g., x percent of the data in the set of data is OOD, or y instances of OOD data detected over a defined period of time). For instance, instances of OOD data may be recorded and tracked in order to detect emerging patterns and shifts in the data.

If the processing system determines in step 214 that a data shift is not present in the set of data, then the method 200 may return to step 204, and the processing system may continue to collect and analyze data from the plurality of sensors as discussed above. If, however, the processing system determines in step 214 that a data shift is present in the set of data, then the method 200 may proceed to step 216. In optional step 216 (illustrated in phantom), the processing system may retrain the machine learning model using the set of data augmented with the instance of out-of-distribution data.

In one example, the set of data augmented with the instance of out-of-distribution data may also be augmented with additional instances of data that were collected or recorded after the last training of the machine learning model. Thus, the augmented set of data may better represent the current distribution of the set of data.

Once the machine learning model has been retrained, the method may return to step 204, and the processing system may continue to collect and analyze data from the plurality of sensors as discussed above.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., at least one central processing unit (CPU), a microprocessor, or a multi-core processor), a memory 304 (e.g., random access memory (RAM) and/or read only memory (ROM)), a module 305 for detecting an anomaly based on an analysis of multi-modal data, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for detecting an anomaly based on an analysis of multi-modal data (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for detecting an anomaly based on an analysis of multi-modal data (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
collecting, by a processing system including at least one processor, a set of data from a plurality of sensors that is monitoring a system, wherein the plurality of sensors includes sensors of a plurality of different modalities;
detecting, by the processing system, an instance of out-of-distribution data in the set of data by providing the set of data as an input to a machine learning model that generates as an output an indicator that the instance of out-of-distribution data is out-of-distribution with respect to the set of data;
identifying, by the processing system, a root cause for the instance of out-of-distribution data; and
initiating, by the processing system, an action to remediate the root cause of the instance of out-of-distribution data.

2. The method of claim 1, wherein the system comprises one of: a communications network, a human body, an autonomous vehicle, a piece of artwork, a physical location at which a crowd is gathered, or a piece of software that is under development.

3. The method of claim 1, wherein the plurality of sensors includes at least two of: an imaging sensor, an audio sensor, a network sensor, a temperature sensor, a weather sensor, a medical sensor, or a biometric sensor.

4. The method of claim 1, wherein at least one sensor of the plurality of sensors is mounted in a fixed location.

5. The method of claim 1, wherein at least one sensor of the plurality of sensors is mounted to a moving object.

6. The method of claim 1, wherein a value of the instance of out-of-distribution data deviates from a mean value for the set of data by more than a predefined threshold value.

7. The method of claim 6, wherein the predefined threshold value is different for each modality of data that is collected by the plurality of sensors.

8. The method of claim 1, wherein a value of the instance of out-of-distribution data deviates from a median value for the set of data by more than a predefined threshold value.

9. The method of claim 1, wherein the machine learning model comprises at least one of: a density-based algorithm, a reconstruction-based algorithm, a classification-based algorithm, or a distance-based algorithm.

10. The method of claim 1, wherein the set of data is transferred into a set of latent representations after the collecting, but prior to the detecting.

11. The method of claim 1, wherein the instance of out-of-distribution data is assigned a score, wherein the score comprises an indication as to how closely the instance of out-of-distribution data fits a distribution of the set of data.

12. The method of claim 11, wherein the score is proportional to a distance between the score and a mean score for the set of data.

13. The method of claim 11, wherein the score is proportional to a distance between the score and a median score for the set of data.

14. The method of claim 1, wherein the identifying is performed using a supervised machine learning technique in which a human operator labels instances of out-of-distribution data in a set of training data with root causes.

15. The method of claim 1, further comprising:
augmenting, by the processing system, a set of training data used to train the machine learning model with the instance of out-of-distribution data.

16. The method of claim 15, wherein the instance of out-of-distribution data is labeled as out-of-distribution before being added to the set of training data.

17. The method of claim 1, further comprising:
detecting, by the processing system, a data shift in the set of data; and
retraining, by the processing system in response to the detecting the data shift, the machine learning model using the set of data augmented with the instance of out-of-distribution data.

18. The method of claim 17, wherein the set of data is further augmented, prior to the retraining, with additional instances of data that were collected after a last training of the machine learning model.

19. A non-transitory computer-readable medium storing instructions which, when executed by a processing system including at least one processor, cause the processing system to perform operations, the operations comprising:
collecting a set of data from a plurality of sensors that is monitoring a system, wherein the plurality of sensors includes sensors of a plurality of different modalities;
detecting an instance of out-of-distribution data in the set of data by providing the set of data as an input to a machine learning model that generates as an output an indicator that the instance of out-of-distribution data is out-of-distribution with respect to the set of data;
identifying a root cause for the instance of out-of-distribution data; and
initiating an action to remediate the root cause of the instance of out-of-distribution data.

20. A device comprising:
a processing system including at least one processor; and
a non-transitory computer-readable medium storing instructions which, when executed by the processing system, cause the processing system to perform operations, the operations comprising:
collecting a set of data from a plurality of sensors that is monitoring a system, wherein the plurality of sensors includes sensors of a plurality of different modalities;
detecting an instance of out-of-distribution data in the set of data by providing the set of data as an input to a machine learning model that generates as an output an indicator that the instance of out-of-distribution data is out-of-distribution with respect to the set of data;
identifying a root cause for the instance of out-of-distribution data; and
initiating an action to remediate the root cause of the instance of out-of-distribution data.
